(19) United States
(12) Patent Application Publication
(10) Pub. No.: US 2025/0313085 A1
(43) Pub. Date: Oct. 9, 2025

(54) ADJUSTABLE SHIM

(71) Applicant: MUNCIE POWER PRODUCTS, INC., MUNCIE, IN (US)

(72) Inventor: James R. Abbott, Farmland, IN (US)

(73) Assignee: MUNCIE POWER PRODUCTS, INC., MUNCIE, IN (US)

(21) Appl. No.: 19/098,539

(22) Filed: Apr. 2, 2025

Related U.S. Application Data
(60) Provisional application No. 63/575,004, filed on Apr. 5, 2024.

(51) Int. Cl. B60K 17/28

(52) U.S. Cl. CPC B60K 17/28

(57) ABSTRACT

This disclosure relates to power takeoff devices (PTOs) useful for mounting on transmissions and for performing, directly or indirectly, useful work via the PTO's rotatable output shaft. More particularly, this disclosure relates to a two-part adjustable shim allowing for repeatable adjustment of the output bearing end play of a PTO assembly without removing the PTO output cover.

This application claims the benefit of U.S. provisional patent application Ser. No. 63/575,004, filed Apr. 5, 2024, for ADJUSTABLE SHIM, which is incorporated herein by reference.

### FIELD

This disclosure relates to power takeoff devices (PTOs) useful for mounting on transmissions and for performing, directly or indirectly, useful work via the PTO's rotatable output shaft. More particularly, this disclosure relates to a two-part adjustable shim allowing for repeatable adjustment of the output bearing end play of a PTO assembly without removing the PTO output cover.

### BACKGROUND

The use of a PTO in association with vehicle (e.g., truck) or stationary engine transmissions is generally known. Such PTOs often include an input gear for connection to an input shaft or transmission, an output gear for connection to an output shaft and, optionally, a clutch mechanism for selectively engaging and disengaging power to the output shaft so as to selectively rotate the output shaft of the PTO to perform useful work, such as to power an auxiliary device. Once connected to a gear within the transmission, the input gear of the PTO is connected to and can draw mechanical power from the transmission.

PTO assemblies typically include a pair of spaced apart tapered roller bearings seated against the output shaft which help to support the shaft through their ability to handle radial and axial loads simultaneously. Tapered roller bearings are manufactured with a cup (i.e., outer race) and cone (i.e., inner race, roller elements and cage). The cup and cone are not fixed together, so the PTO assembly must make accommodations to ensure that the cup and cone of each bearing stay in the proper position. The total distance the output shaft can move between the two spaced apart tapered roller bearings in an axial direction is typically referred to as “end play” but is also referred to as float, thrust bearing clearance or axial clearance. Bearing life is reduced if there is too much end play and the shaft is able to move in an axial direction. On the other hand, bearing life is also reduced by excessive preload is placed on the bearings to prevent end play. Machining tolerances on various PTO assembly components can lead to excessive variation of tapered roller bearing end play in PTO assemblies.

To compensate for such variation and achieve the desired end play, PTO assemblies often include features to adjust the end play. PTO assemblies are frequently designed to have adjustability in the housing in order to affect end play. A common embodiment is a two-piece housing assembly including a housing and an output cover, wherein a user inserts a shim of a specific thickness between the housing and output cover to adjust the end play. In such embodiments, the components for the PTO assembly is assembled and the end play is measured. A shim with the desired thickness is then selected and placed between housing and output cover. The PTO assembly is then reassembled and the end play is again measured. The process is repeated as necessary until the desired end play is achieved. This method of end play adjustment has several disadvantages including the need to stock a wide range of shims in various thicknesses and the need to repeatedly assemble, disassemble and reassemble the PTO assembly until the desired end play is achieved.

A need exists for a system and method for effectively adjusting the end play of a PTO output shaft without requiring disassembly and reassembly of the PTO assembly during the end play adjustment. Certain preferred features of the present disclosure address these and other needs and provide other important advantages.

### SUMMARY

Embodiments of the present disclosure include a two-part adjustable shim configured to use with a PTO assembly. The disclosed adjustable shim is configured for attachment between the housing and output cover of the PTO assembly. The adjustable shim includes a first part and a second part, each with varying cross-sectional thickness. The first part and second part are positioned between the housing and output cover of a PTO assembly and may be rotated with respect to each other to vary the total thickness of the adjustable shim for adjustment of end play. In some embodiments, at least one of the first part and second part are labeled with indicia reflective of predetermined increments of rotation corresponding to predetermined changes in thickness of the adjustable shim.

In some embodiments, the present invention is an adjustable shim comprising a first part in the shape of a thin ring with an inner circumference, an outer circumference, a front face and an opposing rear face, wherein the outer circumference includes a plurality of spaced semi-circular cutouts, and wherein the front face of the first part is substantially flat and the rear face of the first part includes a plurality of ramps; and a second part in the shape of a thin ring with an inner circumference, an outer circumference, a front face, and an opposing rear face, wherein the rear face of the second part is substantially flat and the front face of the second part includes a plurality of ramps; wherein the rear face of the first part contacts the front face of the second part such that rotation of the first part with respect to the second part varies a thickness of the adjustable shim. In further embodiments, the adjustable shim includes a flange extending radially from the outer circumference of the second part, the flange including a plurality of indicia. In certain embodiments, the adjustable shim includes a tab extending radially from the outer circumference of the first part, the tab including an aperture sized to reveal one of the plurality of indicia when the first part is rotated with respect to the second part such that the tab overlays said one of the plurality of indicia. In some embodiments, the adjustable shim includes one or more protrusions extending from the outer circumference of the second part, each of the one or more protrusions including an aperture and two spaced apart apertures extending through the flange of the second part. In further embodiments, the apertures extending through the flange in the second part, each aperture in the one or more protrusions in the second part, and each of the plurality of semi-circular cutouts in the first part have approximately equal radii.

In other embodiments, the present invention is a power takeoff (PTO) assembly comprising a housing; a output cover; and an adjustable shim positioned between the housing and the cover, wherein the adjustable shim includes a first part in the shape of a thin ring with an inner circumference, an outer circumference, a front face and an opposing rear face, wherein the outer circumference includes a plurality of spaced semi-circular cutouts, and wherein the front face of the first part is substantially flat and the rear face of the first part includes a plurality of ramps; and a second part in the shape of a thin ring with an inner circumference, an outer circumference, a front face, and an opposing rear face, wherein the rear face of the second part is substantially flat and the front face of the second part includes a plurality of ramps; wherein the rear face of the first part contacts the front face of the second part such that rotation of the first part with respect to the second part varies a thickness of the adjustable shim. In further embodiments, the housing includes a cover contact surface and a raised collar centered within the cover contact surface; wherein the output cover is sized and shaped to receive at least a portion of the raised collar within an interior of the output cover; and wherein the adjustable shim contacts the cover contact surface and radially surrounds the raised collar. In certain embodiments, the flat rear face of the second part contacts the cover contact surface, the front face of the second part contacts the rear face of the first part, and the flat front face of the first part contacts the output cover. In some embodiments, the output cover is attached to the housing using a plurality of fasteners extending into corresponding threaded holes in the housing. In further embodiments, the second part of the adjustable shim includes one or more protrusions extending from the outer circumference of the second part, each of the one or more protrusions including an aperture; wherein two spaced apart apertures extend through the flange of the second part; and wherein the apertures in the one or more protrusions and the apertures in the flange are aligned with the threaded holes in the housing such that each of the plurality fasteners extends through an aperture and into a threaded hole. In certain embodiments, the semi-circular cutouts in the first part of the adjustable shim mechanically engage the plurality of fasteners. In some embodiments, the PTO assembly includes a flange extending radially from the outer circumference of the second part, the flange including a plurality of indicia; and a tab extending radially from the outer circumference of the first part, the tab including an aperture sized to reveal one of the plurality of indicia when the first part is rotated with respect to the second part such that the tab overlays said one of the plurality of indicia.

In further embodiments, the present invention is a method for adjusting the end play of a power takeoff (PTO) assembly, the method comprising assembling a PTO assembly comprising a housing and an output cover, with an adjustable shim as described above positioned between the housing and the output cover, the adjustable shim being in a first configuration; measuring the end play of the PTO assembly; determining the difference between the measured end play and a desired end play; rotating the first part of the adjustable shim with respect to the second part of the adjustable shim to adjust the thickness of the adjustable shim by an amount substantially equal to the difference between the measured end play and the desired end play; and securing the housing to the adjustable shim and to the output cover wherein, after said securing, the first part of the adjustable shim is fixed with respect to the second part of the adjustable shim. In some embodiments, the output cover is secured to the housing using a plurality of fasteners extending from the output cover, through apertures in the second part, and into corresponding threaded holes in the housing. In further embodiments, the semi-circular cutouts in the first part of the adjustable shim mechanically engage the plurality of fasteners.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example only, and are not to be construed as limiting the scope of this invention.

FIG. 1A is a side view of a first part of an embodiment of an adjustable shim.

FIG. 1B is a rear view of the first part of FIG. 1A.

FIG. 1C is a side sectional view of the first part of FIG. 1A along lines A-A of FIG. 1B.

FIG. 1D is a front view of the first part of FIG. 1A.

FIG. 2A is a side view of a second part of the embodiment of an adjustable shim.

FIG. 2B is a front view of the second part of FIG. 2A.

FIG. 2C is a side sectional view of the second part of FIG. 2A along lines B-B of FIG. 2B.

FIG. 2D is a rear view of the second part of FIG. 2A.

FIG. 3 is an exploded front/side perspective view of the adjustable shim in proximity to an exemplary PTO.

FIG. 4A is a front perspective view of the exemplary PTO with the adjustable shim attached thereto.

FIG. 4B is a front view of the exemplary PTO of FIG. 4A with the output flange omitted for clarity.

FIG. 4C is a cross-sectional side view of the exemplary PTO of FIG. 4B along lines-C-C of FIG. 4B.

FIG. 5A is a front perspective view of the exemplary PTO with the adjustable shim attached thereto.

FIG. 5B is a front view of the exemplary PTO of FIG. 5A with the output flange omitted for clarity.

FIG. 5C is a cross-sectional side view of the exemplary PTO of FIG. 5B along lines-D-D of FIG. 5B.

### DETAILED DESCRIPTION OF THE ILLUSTRATED EMBODIMENTS

For the purposes of promoting an understanding of the principles of the invention disclosed herein, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated. When used with a numerical value, the terms “about,” “approximately,” or “substantially” mean, unless otherwise specified, a range of numerical values within ten percent of the most precise significant digit in the stated value. For example “about 10” means the range from 9 to 11, while “about 10.0” means the range from 9.9 to 10.1. Similarly, the terms when used with a textual description of a numerical parameter, such as “substantially perpendicular” means an angle within ten percent of 90 degrees to a given surface (e.g., 81 degrees to 99 degrees).

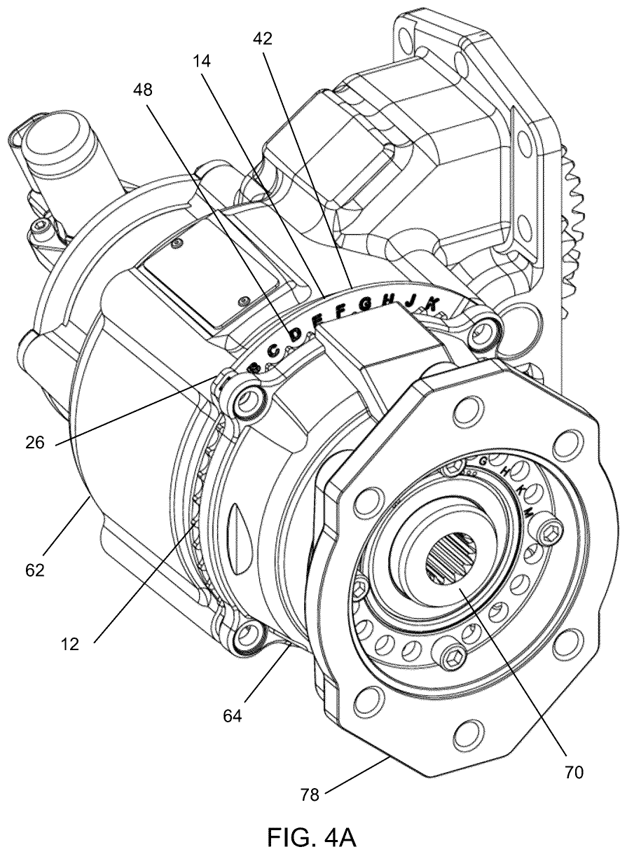

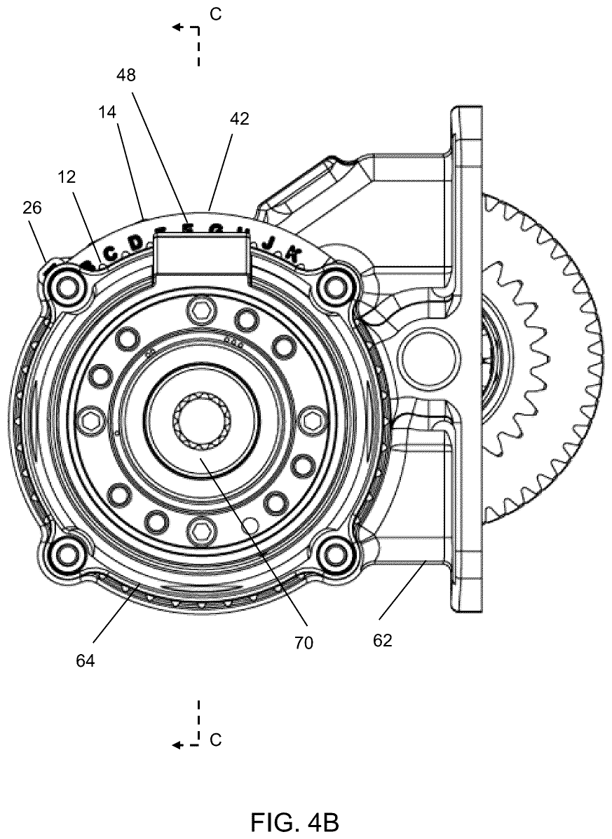

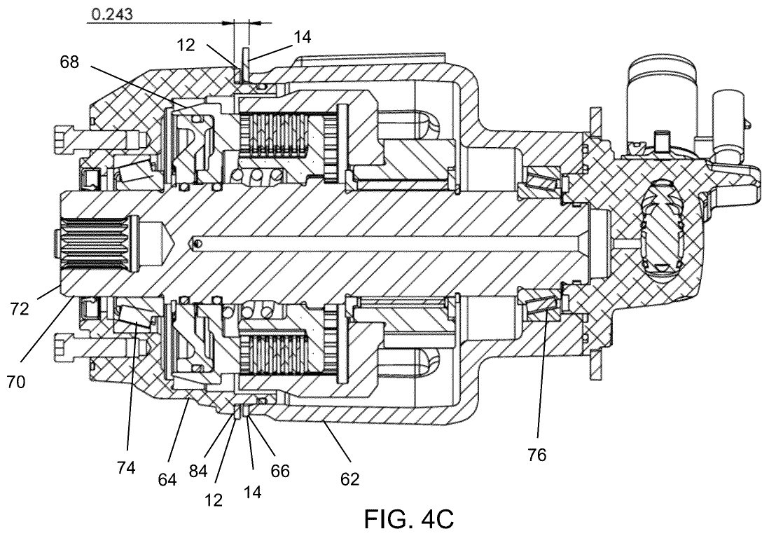

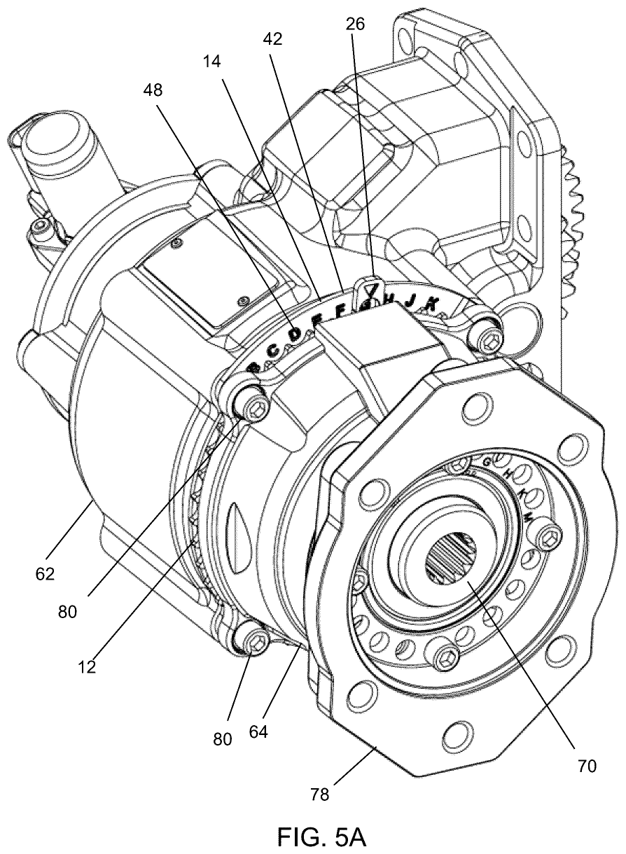

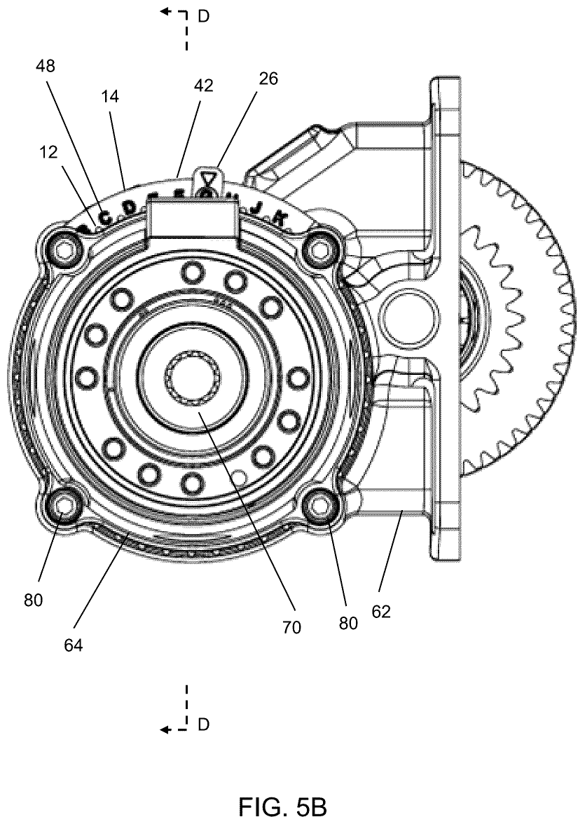

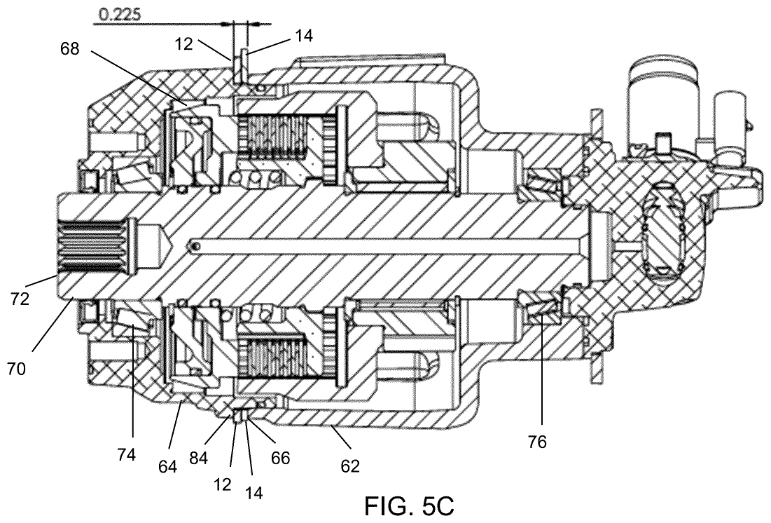

Reference systems that may be used herein can refer generally to various directions, which are merely offered to assist the reader in understanding the various embodiments of the disclosure and are not to be interpreted as limiting. Other reference systems may be used to describe various embodiments. In the nomenclature of this document, the “front” is the direction oriented toward the viewer in FIGS. 4B and 5B, aligned with the axis of the PTO output shaft, and the “rear” is the opposite direction. It should be understood that a PTO may be attached to a transmission in various orientations, such that the front of the PTO and the front of the adjustable shim may or may not be oriented toward the front of the vehicle to which the transmission pertains.

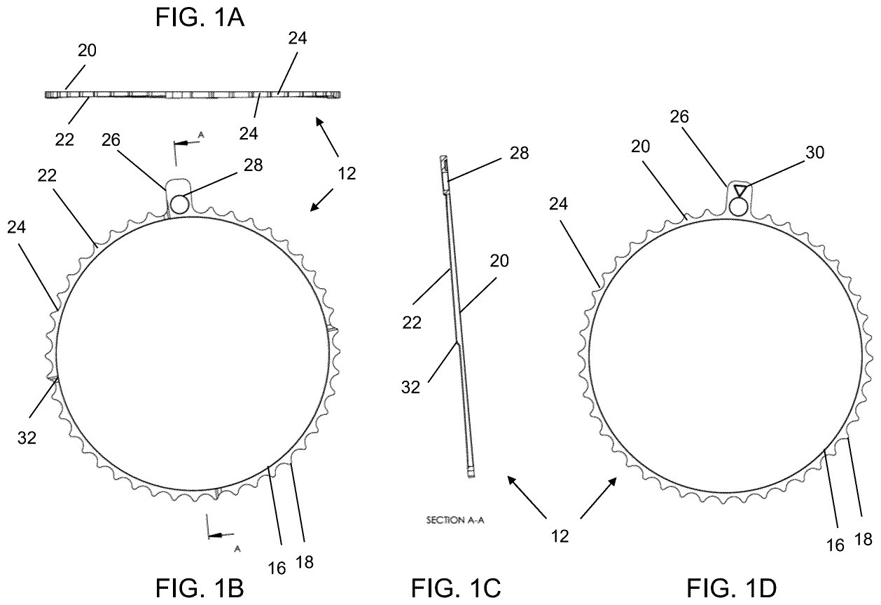

An embodiment of an adjustable shim 10 includes a first part 12 and a second part 14. Referring now to FIGS. 1A-1D, the first part 12 is in the shape of a thin ring with an inner circumference 16, an outer circumference 18, a front face 20 and an opposing rear face 22. The inner circumference 16 is an uninterrupted circular shape and the outer circumference 18 is ridged, with a plurality of spaced semi-circular cutouts 24. The first part 12 further includes a tab 26 extending radially from the outer circumference 18, the tab 26 including an aperture 28. The front face 20 optionally includes an indicator 30 on the tab 26, shown here as a triangle. In one embodiment, the outer circumference 18 includes forty-three cutouts 24, each spaced across approximately 8.18 degrees of arc with the remaining approximately 8.26 degrees of arc being the tab 26. In some embodiments, the inner diameter of the first part 12 is about 5.36 inches and the outer diameter is about 5.88 inches. The front face 20 of the first part 12 is substantially flat. The rear face 22 includes a plurality of ramps 32 extending around the ring-shaped first part 12. In the depicted embodiment, the rear face 22 includes four ramps 32, each equally spaced and extending along approximately 90 degrees of arc. In one embodiment, each ramp 32 has a height of 0.05 inches, such that the thickness of the first part 12 (i.e., the distance between the front face 20 and the rear face 22) ranges from 0.075 inches to 0.125 inches.

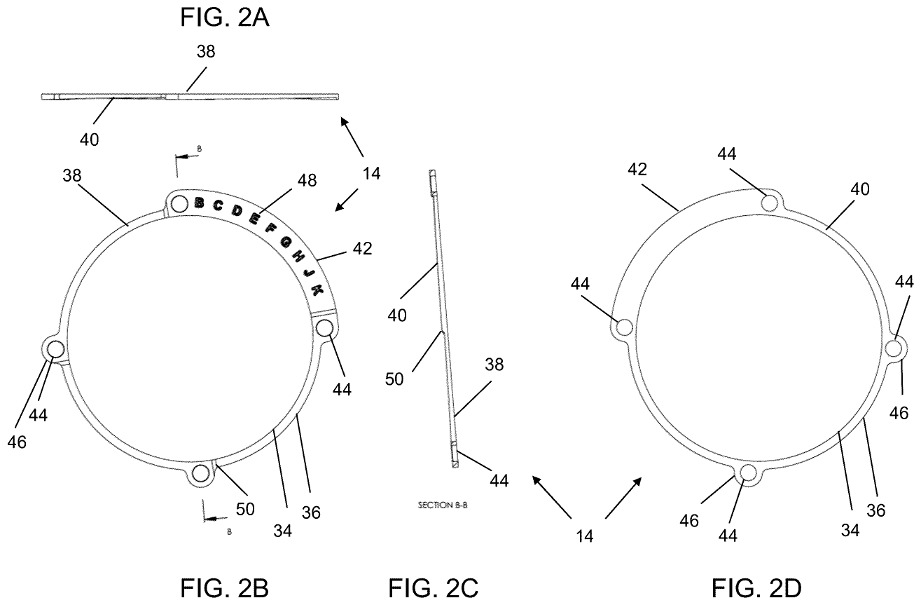

Referring now to FIGS. 2A-2D, the second part 14 is in the shape of a thin ring with an inner circumference 34, an outer circumference 36, a front face 38 and an opposing rear face 40. The inner circumference 34 is an uninterrupted circular shape. The outer circumference 36 generally circular in shape, and includes a flange 42 extending radially from the outer circumference 36 and encompassing approximately 90 degrees of arc around the outer circumference 36. The flange 42 includes two apertures 44, each spaced approximately 90 degrees apart. The second part 14 further includes two protrusions 46 extending radially from the outer circumference 36, each including an aperture 44. The apertures 44 in the protrusions 46 and the apertures 44 in the flange 42 cooperatively provide the second part 14 with four apertures 44 each spaced approximately 90 degrees apart. The front face 36 includes a plurality of indicia 48 on the flange 42, shown here as the letters B, C, D, E, F, G, H, J, and K. In other embodiments, the plurality of indicia 48 may be the numbers 1-9, the letters A-I, or any other desired indicia. In some embodiments, the inner diameter of the second part is about 5.36 inches and the outer diameter is about 5.71 inches and increases to about 6.39 inches at the flange 42 and the protrusions 46. The rear face 40 of the second part 14 is substantially flat. The front face 38 includes a plurality of ramps 50 extending around the ring-shaped second part 14. In the depicted embodiment, the front face 38 includes four ramps 50, each equally spaced and extending along approximately 90 degrees of arc. Each ramp 50 has a height of 0.05 inches, such that the thickness of the second part 14 (i.e., the distance between the front face 38 and the rear face 38) ranges from 0.075 inches to 0.125 inches.

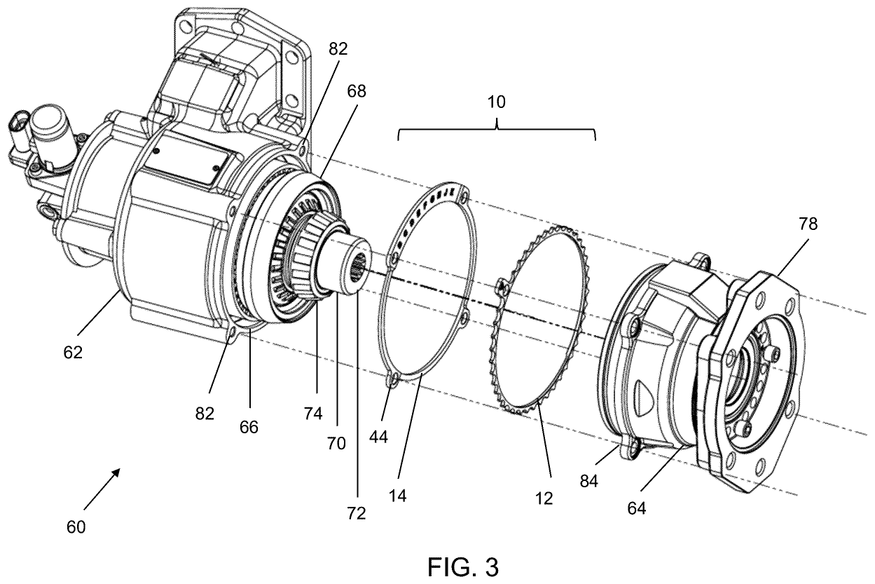

As shown in FIGS. 3, 4A-4C and 5A-5C an exemplary PTO assembly 60 includes a housing 62 and an output cover 64. The housing 62 includes a cover contact surface 66 and a raised collar 68 centered within the cover contact surface 66. The PTO assembly 60 further includes an output shaft 70 having an end 72, the output shaft 70 being positioned partially within the housing 62 and extending from the raised collar 68. The PTO assembly 60 further includes a first tapered roller bearing 74 within the raised collar 68, the first tapered roller bearing 74 radially surrounding the output shaft 70. A second tapered roller bearing 76 radially surrounds the output shaft 70 in proximity to the opposite end of the output shaft 70. In the depicted embodiment, the output cover 64 is sized and shaped to receive at least a portion of the raised collar 68, output shaft 70 and first tapered roller bearing 74 within its interior. The output cover 64 optionally includes an output flange 78 for mechanical engagement between the PTO assembly 60 and an auxiliary device (not shown) to be driven by the output shaft 70. In the depicted embodiment, the output cover 64 is attached to the housing using four cap screws 80. When the output cover 64 is mounted on the housing 62, the output shaft 70, first tapered roller bearing 74 and raised collar extend 68 into the output cover 62. Mechanical engagement between the interior of the output cover 62 and the first tapered roller bearing 74 controls the end play of the output shaft 70. However, machining tolerances on the housing 62 and output cover 64 can lead to excessive variation in the end play so it is not feasible to simply machine the housing 62 and output cover 64 to have a desired end play.

The adjustable shim 10 is configured to contact the cover contact surface 66, radially surround the raised collar 68, and fit between the housing 62 and the output cover 64. The flat rear face 40 of the second part 14 contacts the cover contact surface 66 and is arranged such that the four apertures 44 in the second part 14 are aligned with four corresponding threaded holes 82 in the housing 62, such that the cap screws 80 may extend through the output cover 64, through the apertures in the second part 44, and into the threaded holes 82 along the path indicated by the four broken lines in FIG. 3. This figure includes an additional broken line extending through the output shaft 70 and indicating the rotational axis of the output shaft 70. Thus the apertures 44 in the second part 14 allow for mechanical connection between the second part 14 and the housing 62, and do not obstruct the mechanical connection between the housing 62 and the output cover 64. The semi-circular cutouts 24 in the first part 12 are sized to mechanically engage the sides of the cap screws 80, such that contact between the cutouts 24 and the cap screws 80 prevents rotation of the first part 12 when the cap screws 80 are installed. In some embodiments, the radius of the apertures 44 is approximately equal to the radius of the semi-circular cutouts 24. The ramped rear face 22 of the first part 12 contacts the ramped front face 38 of the second part 14. The flat front face 20 of the first part 12 contacts the output cover 64. By rotating the first part 12 with respect to the second part 14, the positioning of the ramps 32 on the rear face 22 of the first part 12 with respect to the ramps 50 on the front face 38 of the second part 14 can be adjusted, changing the thickness of the adjustable shim 10 and thus adjusting the end play of the PTO assembly 60. The first part 12 may be rotated with respect to the second part 14 when the cap screws 80 are not installed, then installation of the cap screws 80 fixes the relative positions of the first part 12 and second part 14.

As shown in FIGS. 4A-4C, the PTO assembly 60 is first assembled with the adjustable shim 10 set in a first configuration, where the ramps 32, 50 are arranged with respect to each other to maximize the total thickness of the adjustable shim 10 and maximize end play. In the depicted embodiment, as shown in FIG. 4C, the adjustable shim 10 in this first configuration results in a spacing of about 0.243 inches between the cover contact surface 66 of the housing 62 and the corresponding housing contact surface of the output cover. Note that the cover contact surface 66 of the housing 62 and the housing contact surface 84 of the output cover 64 do not directly contact each other due to the intervening adjustable shim 10, but would directly contact each other if the output cover 64 was attached to the housing 62 absent the adjustable shim 10.

Once assembled in this configuration, the end play of the output shaft 70 is measured using techniques and devices as commonly known in the field. Depending on the difference between the measured end play and the desired end play, the first part 12 of the adjustable shim 10 is rotated with respect to the second part 14, bringing thinner portions of the respective ramps 32, 50 in contact with each other and decreasing the total thickness of the adjustable shim 10. FIGS. 5A-5C show the PTO assembly 10 with the first part 12 rotated with respect to the second part 14 as compared to FIGS. 4A-4C. Also, cap screws 82 are installed in FIGS. 5A-5C The indicia 48 on the second part 14 provide a visual indication of different end play settings. Rotating the first part 12 with respect to the second part 14 changes which indicia 48 (or if any indicia 48) is visible in the aperture 28 in the tab 26 in the first part 12.

In the depicted embodiment, each letter indicia 48 indicates an adjustment of 0.003 inches in the total thickness of the adjustment shim 10. In other embodiments, the ramps 32 on the rear face 22 of the first part 12 and the ramps 50 on the front face 38 of the second part 14 may have a greater pitch and height, providing a greater range in the thickness of each part 12, 14, or may have a lower pitch and lower height, providing a smaller range in the thickness of each part 12, 14. In embodiments with greater ramp height, rotating the first part 12 by one indicia 48 would reflect a greater adjustment to the thickness of the adjustable shim 10. Correspondingly, in embodiments with a lower ramp height, rotating the first part 12 by one indicia 48 would reflect a lower adjustment to the thickness of the adjustable shim 10. In a typical PTO assembly 10, as shown in FIGS. 3, 4A-4C and 5A-5C, the desired end play is a narrow range measured in hundredths of an inch, such as, for example, between 0.002 and 0.007 inches, such that the indicia 48 and pitch and height of the ramps 32, 50 are selected to allow the end play to be set within such fine tolerance limits. Once the adjustable shim 10 is rotated from the first configuration, where the ramps 32, 50 are arranged to maximize the total thickness of the shim 10, to a second configuration, where the thickness is decreased and the desired end play is achieved, cap screws 82 are inserted through the output cover 64, through the apertures 44 in the second part 14, and into the threaded holes 82 in the housing 62. As discussed above, mechanical engagement between the semi-circular cutouts 24 in the first part 12 and the sides of the cap screws 82 prevents rotation of the first part 12.

The present invention simplifies adjustment of the end play in the output shaft 70 of a PTO assembly 60. As previously stated, the typical process is to assemble a PTO assembly by mounting the output cover on the housing with an initial shim, sometimes referred to as a master shim, inserted between the output cover and housing and then measure the end play. If the measured end play is less than the desired end play, the PTO assembly is disassembled, a thicker shim or an additional shim is added between the housing and output cover, and the PTO assembly is reassembled. If the measured end play is greater than the desired end play, the PTO assembly is disassembled and an existing shim is replaced with a thinner shim or a shim is removed. The PTO assembly is then reassembled and the end play is again measured. The process is repeated as necessary until the desired end play is achieved. With the present invention, the PTO assembly 60 is assembled once with the adjustable shim 10 inserted between the housing 62 and output cover 64. The end play is initially measured using techniques and devices as generally known in the art with the adjustable shim 10 set at a first configuration with maximum thickness. Depending on the difference between the measured end play and the desired end play, the first part 12 of the adjustable shim 10 is rotated with respect to the second part 14 without removing the output cover 64 to align the tab 26 with the appropriate indicia 48 indicating the desired adjustment. For example, if each indicia 48 reflects a difference of 0.002 inches in thickness and the initial measurement of the end play with the adjustable shim 10 set to maximum thickness indicates a measured end play 0.010 greater than the desired end play, the first part 12 will be rotated to align with the fifth indicia 48 on the second part 14 to decrease the end play to the desired value. Once the end play is set to the desired value, cap screws 82 are installed, securing the output cover 64 to the housing 62 and preventing further rotation of the first part 12 with respect to the second part 14. The present invention requires the PTO assembly 10 to be assembled only once to achieve the desired end play, while the typical process for shimming requires the PTO assembly to be assembled and disassembled multiple times to achieve the desired end play.

While the housing 62 and output cover 64 are described as being attached using cap screws 80 inserted into threaded holes 82, it should be understood that bolts, machine screws, clamps, or other mechanical fastening means as known in the art may also or alternatively be used.

While the disclosure discusses and shows a housing 62 and output cover 64 attached by four cap screws 80, in other embodiments, the housing 62 and output cover 64 may be attached by three, five, six, or other numbers of cap screws 80 or other fasteners. The present disclosure contemplates adjustable shims configured for such other PTO assemblies by including fewer or additional protrusions with apertures around the outer circumference of the second part. As a first example, a second part of an adjustable shim designed for use with a PTO assembly wherein the housing and output cover are attached by three equally spaced cap screws (not shown) would include a flange extending radially from the outer circumference and encompassing approximately 120 degrees of arc around the outer circumference. The flange would include two apertures, each spaced 120 degrees apart. The second part would further include one protrusion extending radially from the outer circumference, the protrusion including an aperture. The apertures in the protrusion and the apertures in the flange cooperatively provide this embodiment of the second part with three apertures each spaced 120 degrees apart. In this exemplary embodiment, the first part and second part may each include three ramps, each equally spaced and extending along approximately 120 degrees of arc.

As a second example, a second part of an adjustable shim designed for use with a PTO assembly wherein the housing and output cover are attached by six equally spaced cap screws (not shown) would include a flange extending radially from the outer circumference and encompassing approximately 60 degrees of arc around the outer circumference. The flange would include two apertures, each spaced 60 degrees apart. The second part would further includes four protrusions extending radially from the outer circumference, each protrusion including an aperture. The apertures in the protrusions and the apertures in the flange cooperatively provide this embodiment of the second part with six apertures each spaced 60 degrees apart. In this exemplary embodiment, the first part and second part may each include six ramps, each equally spaced and extending along approximately 60 degrees of arc.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

1. An adjustable shim, comprising:
a first part in the shape of a thin ring with an inner circumference, an outer circumference, a front face and an opposing rear face, wherein the outer circumference includes a plurality of spaced semi-circular cutouts, and wherein the front face of the first part is substantially flat and the rear face of the first part includes a plurality of ramps; and
a second part in the shape of a thin ring with an inner circumference, an outer circumference, a front face, and an opposing rear face, wherein the rear face of the second part is substantially flat and the front face of the second part includes a plurality of ramps;
wherein the rear face of the first part contacts the front face of the second part such that rotation of the first part with respect to the second part varies a thickness of the adjustable shim.

2. The adjustable shim of claim 1, further comprising a flange extending radially from the outer circumference of the second part, the flange including a plurality of indicia.

3. The adjustable shim of claim 2, further comprising a tab extending radially from the outer circumference of the first part, the tab including an aperture sized to reveal one of the plurality of indicia when the first part is rotated with respect to the second part such that the tab overlays said one of the plurality of indicia.

4. The adjustable shim of claim 1, further comprising:
one or more protrusions extending from the outer circumference of the second part, each of the one or more protrusions including an aperture; and
two spaced apart apertures extending through the flange of the second part.

5. The adjustable shim of claim 4, wherein the apertures extending through the flange in the second part, each aperture in the one or more protrusions in the second part, and each of the plurality of semi-circular cutouts in the first part have approximately equal radii.

6. A power takeoff (PTO) assembly comprising:
a housing;
a output cover; and
an adjustable shim positioned between the housing and the cover, wherein the adjustable shim includes:
a first part in the shape of a thin ring with an inner circumference, an outer circumference, a front face and an opposing rear face, wherein the outer circumference includes a plurality of spaced semi-circular cutouts, and wherein the front face of the first part is substantially flat and the rear face of the first part includes a plurality of ramps; and
a second part in the shape of a thin ring with an inner circumference, an outer circumference, a front face, and an opposing rear face, wherein the rear face of the second part is substantially flat and the front face of the second part includes a plurality of ramps;
wherein the rear face of the first part contacts the front face of the second part such that rotation of the first part with respect to the second part varies a thickness of the adjustable shim.

7. The power takeoff (PTO) assembly of claim 6,
wherein the housing includes a cover contact surface and a raised collar centered within the cover contact surface;
wherein the output cover is sized and shaped to receive at least a portion of the raised collar within an interior of the output cover; and
wherein the adjustable shim contacts the cover contact surface and radially surrounds the raised collar.

8. The power takeoff assembly of claim 7, wherein the flat rear face of the second part contacts the cover contact surface, the front face of the second part contacts the rear face of the first part, and the flat front face of the first part contacts the output cover.

9. The power takeoff assembly of claim 6,
wherein the output cover is attached to the housing using a plurality of fasteners extending into corresponding threaded holes in the housing.

10. The power takeoff assembly of claim 9,
wherein the second part of the adjustable shim includes one or more protrusions extending from the outer circumference of the second part, each of the one or more protrusions including an aperture;
wherein two spaced apart apertures extend through the flange of the second part; and
wherein the apertures in the one or more protrusions and the apertures in the flange are aligned with the threaded holes in the housing such that each of the plurality fasteners extends through an aperture and into a threaded hole.

11. The power takeoff assembly of claim 9, wherein the semi-circular cutouts in the first part of the adjustable shim mechanically engage the plurality of fasteners.

12. The power takeoff assembly of claim 6, further comprising:
a flange extending radially from the outer circumference of the second part, the flange including a plurality of indicia; and
a tab extending radially from the outer circumference of the first part, the tab including an aperture sized to reveal one of the plurality of indicia when the first part is rotated with respect to the second part such that the tab overlays said one of the plurality of indicia.

13. A method for adjusting the end play of a power takeoff (PTO) assembly, the method comprising:
assembling a PTO assembly comprising a housing and an output cover, with an adjustable shim according to claim 1 positioned between the housing and the output cover, the adjustable shim being in a first configuration;
measuring the end play of the PTO assembly;
determining the difference between the measured end play and a desired end play;
rotating the first part of the adjustable shim with respect to the second part of the adjustable shim to adjust the thickness of the adjustable shim by an amount substantially equal to the difference between the measured end play and the desired end play; and
securing the housing to the adjustable shim and to the output cover wherein, after said securing, the first part of the adjustable shim is fixed with respect to the second part of the adjustable shim.

14. The method of claim 13, wherein the output cover is secured to the housing using a plurality of fasteners extending from the output cover, through apertures in the second part, and into corresponding threaded holes in the housing.

15. The method of claim 14, wherein the semi-circular cutouts in the first part of the adjustable shim mechanically engage the plurality of fasteners.
